(19) United States
(12) Patent Application Publication
(10) Pub. No.: US 2024/0176169 A1
(43) Pub. Date: May 30, 2024

(54) PULSE-DENSITY MODULATION FOR TUNING A THERMALLY CONTROLLED, RESONANT OPTICAL COMPONENT

(71) Applicants: Subal Sahni, La Jolla, CA (US); Philip Winterbottom

(72) Inventors: Subal Sahni, La Jolla, CA (US); Philip Winterbottom

(21) Appl. No.: 18/523,667

(22) Filed: Nov. 29, 2023

Related U.S. Application Data
(60) Provisional application No. 63/428,663, filed on Nov. 29, 2022.

(51) Int. Cl. G02F 1/01

(52) U.S. Cl. CPC G02F 1/0147; G02F 1/0113; G02F 2203/15; G02F 2203/26

(57) ABSTRACT

One some embodiments, a method for tuning optical components includes receiving an optical signal in a waveguide in a photonic-integrated circuit (PIC) and detecting optical outputs of the optical components. The method further includes determining pulse signals for the optical components designed to cause the optical components to each have a peak-resonance wavelength that matches a corresponding wavelength of the optical signal. The method further includes tuning the optical components by sending the pulse signals to the optical components.

### CROSS-REFERENCE TO RELATED APPLICATIONS

This application claims priority to and benefit of U.S. Provisional Patent Application No. 63/428,663, filed Nov. 29, 2022, which is incorporated herein by reference in its entirety. In addition, this application incorporates by reference U.S. patent application Ser. No. 17/807,694, entitled MULTI-CHIP ELECTRO-PHOTONIC NETWORK, filed on Jun. 17, 2022 (hereinafter referred to as the '694 Application).

### BACKGROUND

Applications like machine learning (ML), deep learning (DL), and natural language processing (NLP) require specialized computing systems capable of handling the massive amounts of data and computations needed to carry out the task. Some implementations include computing environments with massive parallel processing power and large amounts of memory available for the data. Hybrid photonic/electronic computing environments have also been designed for these applications, which can take advantage of a photonic layer to process and/or move data in the photonic domain. Utilizing the photonic layer has the benefits of high-speed and low-power and contributes to the feasibility of computing systems that can handle ML, DL, and NLP tasks.

A drawback of using a computing environment that has a photonic layer is that some optical components in the photonic layer can be narrow-band devices whose peak resonance wavelength varies with thermal conditions. In a chip-to-chip configuration the electrical layer and the photonic layer are positioned with spacings that can be smaller than 50 microns. The electrical layer generates a variable amount of heat which is distributed to the photonic layer inconsistently. When the thermal conditions in the photonic layer change, the behavior of narrow-band optical components also changes. A hybrid photonic/electronic computing environment must account for the changes in thermal conditions in the photonic layer, so that the optical components are tuned sufficiently to process data in the photonic domain.

### SUMMARY

In some embodiments, a method of tuning temperature controlled resonant optical components (TCROCs) of a photonic integrated circuit (PIC), includes, at several consecutive iterations of a time cycle, detecting a plurality of optical outputs generated by the plurality of TCROCs, wherein the plurality of TCROCs generate the plurality of optical outputs based on receiving an optical signal from a light source. The method further includes, at each time cycle, determining a pulse signal for each of the plurality of TCROC configured to shift a peak resonance wavelength of an associated TCROC to substantially match the wavelength of the light source. The method further includes, at each time cycle, applying, with a thermal tuner driver, the associated pulse signal to each of the plurality of TCROCs, wherein each of the pulse signals is applied during a non-overlapping segment of the time cycle.

In some embodiments, a method of tuning temperature controlled resonant optical components (TCROCs) of a photonic integrated circuit (PIC) includes detecting a first optical output of a first TCROC and a second optical output of a second TCROC. The method further includes determining a first pulse signal for the first TCROC and a second pulse signal for the second TCROC each designed to shift a peak resonance wavelength of the associated TCROC to substantially match a target wavelength of a light source. The method further includes, with a thermal tuner driver, applying the first pulse signal to the first TCROC to heat the first TCROC to a first target temperature associated with the first TCROC operating at the target wavelength. The method further includes, with the thermal tuner driver, while allowing the first TCROC to cool below the first target temperature, applying the second pulse signal to the second TCROC to heat the second TCROC to a second target temperature associated with the second TCROC operating at the target wavelength. The method further includes, with the thermal tuner driver, while allowing the second TCROC to cool below the second target temperature, reapplying the first pulse signal to the first TCROC to heat the first TCROC back to the first target temperature, wherein the first pulse signal is reapplied to the first TCROC within a minimum repetition period that is derived from a thermal time constant of the first TCROC.

In some embodiments, a device for tuning optical components of a photonic integrated circuit (PIC) includes a first thermally controlled resonant optical component (TCROC) configured to receive light from a light source and generate a first optical output, the first TCROC having a first peak resonance wavelength that varies with a first temperature of the first TCROC. The device further includes a second TCROC configured to receive light from the light source and generate a second optical output, the second optical output having a second peak resonance wavelength that varies with a second temperature of the second TCROC. The device further includes at least one detector operatively coupled to the first and second TCROC for detecting the first and second optical outputs. The device further includes a control module configured to determine, based on the first and second optical outputs detected by the at least one detector, a first pulse signal and a second pulse signal. The first pulse signal is designed to change the first temperature and cause the first peak resonance wavelength to substantially match a wavelength of the light source. The second pulse signal is designed to change the second temperature and cause the second peak resonance wavelength to substantially match the wavelength of the light source. The device further includes a thermal tuner driver configured to apply the first pulse signal to the first TCROC and apply the second pulse signal to the second TCROC.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set fourth herein, and in part will be obvious from the description, or may be learned by the practice of such embodiments.

### BRIEF DESCRIPTION OF THE DRAWINGS

FIG. 1 illustrates the behavior of a prior art system that includes a thermally controlled, resonant optical component (TCROC);

FIG. 2 shows elements and features of a ML processor, according to at least one embodiment of the present disclosure;

FIG. 3 depicts a cross-sectional view of a ML processor according to at least one embodiment of the present disclosure;

FIG. 4 illustrates an example of ML processors connected in a multi-chip configuration, according to at least one embodiment of the present disclosure;

FIG. 5 illustrates an example pulse density signal generated by a pulse density generator, according to at least one embodiment of the present disclosure;

FIG. 6 shows an example thermal tuner driver, according to at least one embodiment of the present disclosure;

FIG. 7A depicts an architecture by which an MPD may sample light in a waveguide of a PIC and provide the sampled light to closed-loop control circuit(s) implanted by a TCROC control module, according to at least one embodiment of the present disclosure;

FIG. 7B depicts an architecture by which an MPD may sample light in a waveguide of a PIC and provide the sampled light to closed-loop control circuit(s) implanted by a TCROC control module, according to at least one embodiment of the present disclosure;

FIG. 8 depicts an architecture by which an MPD may sample light in a waveguide of a PIC and provide the sampled light to closed-loop control circuit(s) implanted by a TCROC control module, according to at least one embodiment of the present disclosure;

FIG. 9 illustrates an operation of an a TCROC control module controlling a system having two TCROCs.

FIG. 10 is a flowchart showing the operation of a startup procedure for an embodiment of a system that uses MUXes in a photonic-integrated circuit (PIC).

FIG. 11 is a flowchart showing the operation of a startup procedure for an embodiment of a system that uses DEMUXes in the PIC.

FIG. 12 is a flowchart showing the operation of a peak-tracking procedure for an embodiment of a system that uses MUXes in the PIC.

FIG. 13 is a flowchart showing the operation of a peak-tracking procedure for an embodiment of a system that uses DEMUXes in the PIC.

FIG. 14 is a flow diagram for a method or a series of acts for tuning temperature controlled resonant optical components of a photonic integrated circuit as described herein, according to at least one embodiment of the present disclosure.

FIG. 15 is a flow diagram for a method or a series of acts for tuning temperature controlled resonant optical components of a photonic integrated circuit as described herein, according to at least one embodiment of the present disclosure.

### DETAILED DESCRIPTION

The present application discloses a method, apparatus, and system for tuning of optical components using pulse-density modulation (PDM) and pulse-width modulation (PWM). Various embodiments are particularly suited for tuning optical components that modulate or demodulate a frequency. Such optical components are referred to generally as thermally controlled resonant optical components (TCROCs). Specific examples include, but are not limited to, a ring, a ring resonator, a single ring resonator, a multiplexer (MUX), a demultiplexer (DEMUX), a ring switch, a Mach-Zehnder Interferometer (MZI) based switch, or any suitable thermal-optical component that is a narrow-band device whose peak resonance wavelength varies depending on its thermal conditions.

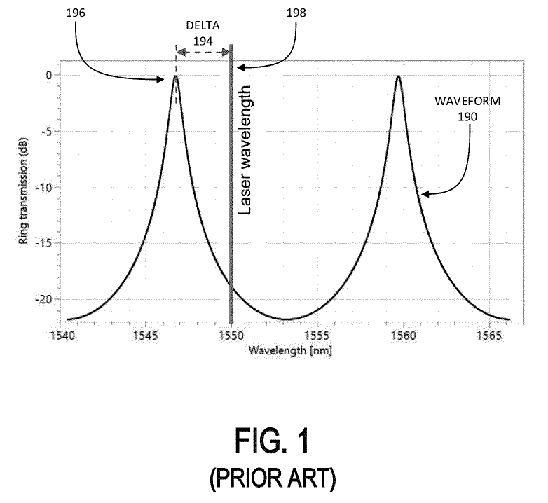

FIG. 1 illustrates the behavior of a prior art system that includes a TCROC. Waveform 190 describes a variability in a peak wavelength of a TCROC. FIG. 1 illustrates the difference between a laser wavelength 198 and a peak resonance wavelength 196 in a system that includes at least one TCROC. Laser wavelength 198 is shown here at 1550 nanometers (nm) where the peak resonance wavelength 196 in the waveform 190 is in the range of 1547 nm. Thus, a delta 194 of 3 nm may exist in the system shown in FIG. 1. As the thermal conditions change with respect to the TCROC described by waveform 190, the peak wavelength may change such that the delta 194 may increase or decrease as the circuit operates. This may create an TCROC that is never fine-tuned to the current conditions and may always have some delta component that may diminish its performance. As a result, various embodiments described herein may thermally tune one or more TCROCs in a system to reduce or even eliminate the delta 194 shown in FIG. 1 for each TCROC. This may be accomplished by a system that adds at least a monitor component in a photonic-integrated circuit (PIC) for every TCROC in a computing environment. The output of the monitor component may provide input to a closed-loop control circuit to tune the resonance of the TCROC to the input laser wavelengths 198 (e.g., move the peak resonance wavelength 196 in waveform 190 to 1550 nm by creating thermal conditions/temperature needed to accomplish this task). Thereafter, the system may track the wavelengths over time through changes in temperature and may continue to adjust the TCROC resonance for each TCROC in a loop. Each TCROC may operate at or near its optimal operating thermal condition at all times according to various embodiments, whenever the computing environment is operating.

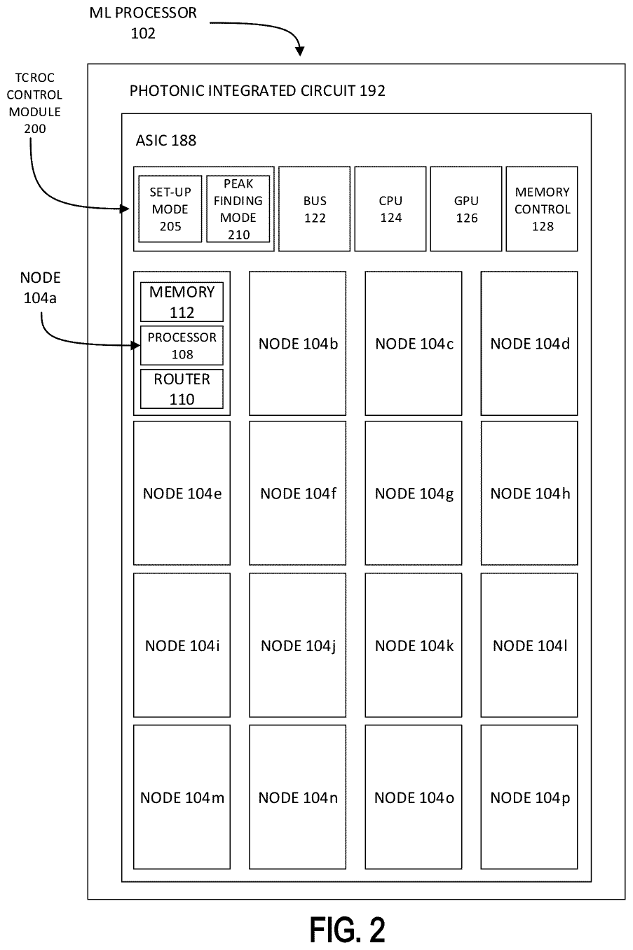

FIG. 2 shows elements and features of a ML processor 102, according to at least one embodiment of the present disclosure. The ML processor 102 may provide a suitable environment that can benefit from various embodiments that use PDM to tune optical components. Various portions, elements, and features of ML processor 102 are not explicitly shown in FIG. 2. As shown in FIG. 2, the ML processor 102 may include sixteen nodes 104a through 104p, arranged in a 4×4, two-dimensional grid. It will be understood by someone having ordinary skill in the art that the 4×4 grid of FIG. 2 is for purposes of example only. The number, arrangement, and dimensionality of the nodes 104a through 104p may vary in different implementations of the ML processor 102. In some embodiments, a photonic integrated circuit (PIC) 192 is stacked on top of a mixed signal, application-specific integrated-circuit (ASIC) 188. In other embodiments, other arrangements and configurations are possible, such as stacking the PIC 192 on top of the ASIC 188 or accessing the PIC 192 and ASIC 188 separately using an interposer.

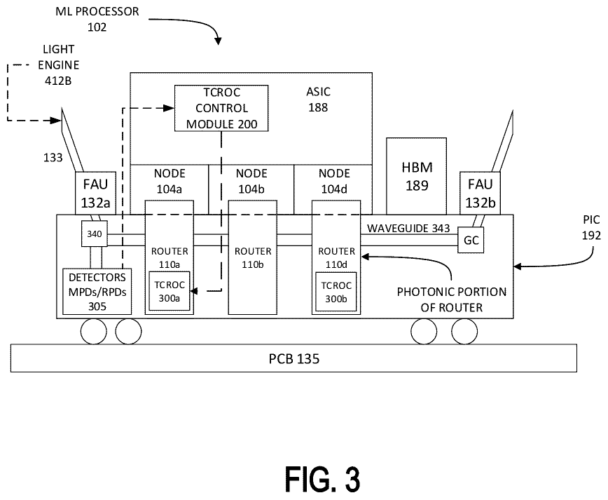

In some embodiments, the ML processor 102 includes a laser light source that sends an optical signal (not shown). The laser light source may be implemented either in the ML processor 102 or externally. For example, an interposer containing several lasers may be co-packaged and edge coupled with the PIC 192. In another example, the lasers may be integrated directly into the PIC 192 using heterogenous or homogenous integration. A homogenous integration may allow lasers to be directly implemented in the silicon photonic substrate and may facilitate lasers of different materials such as Indium Phosphide, and architectures such as quantum-dot lasers. A heterogenous assembly of lasers on the PIC 192 may allow for group III-V semiconductors or other materials to be precision attached onto the PIC 192 and coupled into a waveguide implemented on the PIC 192. As mentioned, the laser light source may be implemented externally, such as by a connection to the ML processor 102. For example, the laser light source may be connected by one or more of a grating coupler, a fiber, and an edge coupler. Further, although not explicitly shown in FIG. 2, the ML processor 102 may include optical links and connections for one or more fiber connections. Fiber connections may be made by several means, such as fiber array units located over grating couplers (FAUs 132a and 132b shown in FIG. 3), edge couplers, or any other suitable connection. As discussed herein, the ML processor 102 may function as a network-on-chip (NoC), and more particularly, a hybrid electro-photonic network-on-chip (EP-NoC).

FIG. 3 depicts a cross-sectional view of the ML processor 102, according to at least one embodiment of the present disclosure. The ML processor 102 may be a system-in-package that includes a chip-to-chip connection between the ASIC 188 and the PIC 192. The ML processor may include grating couplers and fiber array units (FAUs) for connections at the edge of the chip. In some embodiments, the ML processor 102 shown in FIG. 3 may be the ML processor 102 shown in FIG. 2 and/or may include any of the features of the ML processor 102 shown and described in FIG. 2.

The PIC 192 may provide a photonic network for interconnecting, among other things, a portion of the electronic elements on the ASIC 188 (while another portion other electronic elements on the ASIC 188 may be interconnected electrically). According to the present application, both electrical and photonic signal routings may be employed, and the signal routing tasks may be apportioned between electrical (or electronic) paths and photonic paths. Several ML processors (e.g., several instances of the ML processor 102) may be interconnected, (i.e., interconnected chip-to-chip or SIP-to-SIP), to result in a single system referred to as an ML accelerator or a multi-processor computing environment. The interconnection of the several ML processors to form the ML accelerator may be interconnected by a photonic fabric. For example, the photonic networks of the several ML processors, along with optical connections, laser light sources, passive optical components, and external optical fibers on a printed circuit board (PCB) 135, which may be utilized in various combinations and configurations along with other photonics elements, may form the photonic fabric. More specific details are described in the '694 Application referenced above, which has been incorporated by reference herein in its entirety.

In the exemplary implementation shown in FIGS. 2 and 3, each of the nodes 104a through 104p in the ML processor 102 may include processor blocks 108. The processor blocks 108 can be one or more processors, such as deep neural network (DNN) processors, tensor engines, hardware math units such as dot-product units or convolution engines, field-programmable gate arrays (FPGAs), central processing units (CPUs), graphics processing units (GPUs), or any other processing component consistent with that described herein, and combinations thereof. In one embodiment, the processor blocks 108 are implemented in electronic form and reside within the ASIC 188. The processor blocks 108 may be used, for example, as AI accelerators to carry out processing of neural networks. As further shown in FIGS. 2 and 3, in one implementation, each of the nodes 104a through 104p includes message routers 110, and memories 112 (which in practice can be multiple memory units including an L1SRAM and an L2SRAM, for example). The L1SRAM can serve as scratchpad memory for each of the nodes 104a through 104p, while the L2SRAM can function as the primary memory for each of the nodes 104a through 104p, for example to store the weights of a machine learning model in close physical proximity to the processor blocks 108. The L2SRAM may store intermediate results during the execution of a machine learning model. The weights may be used in each layer of a neural network within each ML processor 102. This may include, for example, making inference calculations. Each layer of the neural network may be implemented by several of the nodes 104a through 104p in the ML processor 102, where each of the nodes 104a through 104p comprise one or more neural nodes or neurons.

As further shown in FIG. 2, the ML processor 102 may include one or more of a bus interface 122, a CPU 124, a GPU 126, a memory controller 128, and a TCROC control module 200. The bus interface 122 may be any suitable bus standard, such as a peripheral component interconnect express (PCIE) interface. The CPU 124 and GPU 126 may be an advanced RISC machine (ARM) core, image processor, or other processing element(s). The external memory controller 128 may support DRAM, NVRAM, SRAM or other type of memory. The bus interface 122 may generally enable electrical interconnections between ML processor 102 and an external component. In particular, weights stored in the memories 112 may be received over the bus interface 122 from an external component, such as a dynamic random-access memory (DRAM). The CPU 124 and/or GPU 126 may interface with a memory device (not shown) which may be external to ML processor 102 and may process image data or perform other computing tasks. The memory controller 128 may communicate with a high bandwidth memory, such as the HBM 189 shown in FIG. 3, which may be external to ML processor 102 or may be integrated into the ML processor 102. Other forms of memory such as non-volatile memory may be attached in a similar manner using a corresponding memory controller in block 128.

TCROC control module 200 may be one or more control circuits having an electrical connection to the PIC 192, for example, to take one or more actions and/or send one or more signals to the PIC 192. This may be, for example, in response to a thermal characteristic and/or a thermal change in a TCROC in the PIC 192 that may alter its peak resonant wavelength. A closed-loop control circuit may be implemented by the TCROC control module 200 which may carry out functionality for a set-up mode 205 and a peak finding mode 210. As discussed herein, a peak finding mode 210 may be used to continually sample the optical signal on the bus waveguides in the PIC 192, such as to determine how to alter the operating characteristics of one or more of the TCROCs 300a and 300b in the PIC 192 and/or to counteract the thermal change that may occur in the PIC 192. This may typically happen when there is a change in the thermal characteristic in the PIC 192. The change in the thermal characteristic may require some action to continue to operate the TCROCs 300a and/or 300b in an efficient and/or enhanced manner in order to minimize or eliminate the delta 194 shown in FIG. 1. In this way, each TCROC 300a or 300b may have a peak resonance frequency that may be tuned precisely with the input laser wavelength.

Referring again to FIG. 3, ASIC 188 is shown as being situated over or stacked on PIC 192. Exemplary nodes 104a, 104b, and 104din ASIC 188 are shown with routers 110a, 110b, and 110d. In some embodiments, a portion of routers 110a, 110b, and 110d reside in the ASIC 188 while another portion resides in the PIC 192. As shown, the routers 110a and 110d may have TCROCs 300a and 300b in the photonic portion of the routers, which may be components of the chip-to chip hardware set-up used to enable chip-to-chip communication. For example, multiple wavelengths may be combined together into a single channel when transmitted from the edge of one chip to another using a TCROC in the form of a MUX. Similarly, when the signal is received by another chip a TCROC in the form of a DEMUX may receive the multiple signals and break them back into their constituent components.

In some embodiments, modulator drivers are situated respectively in the portions of the routers 110a, 110b, and 110d that reside in the ASIC 188 and are used to transmit data from the ASIC 188 to the PIC 192. Transimpedance amplifiers (TIAs) may be situated respectively in the portions of the routers 110a, 110b, and 110d that reside in the ASIC 188 and may be used to receive data from the PIC 192 to the ASIC 188. In some embodiments, optical modulators are situated directly below respective modulator drivers in the portion of the routers 110a, 110b, and 110d that reside in the PIC 192. Photodetectors (PDs) may be situated directly below respective TIAs in the portion of the routers 110a, 110b, and 110d that reside in the PIC 192. Optical links, such as waveguide 343 may provide optical paths in the PIC 192 that may be part of the photonic network for intra-chip communication between the ASIC nodes 104a, 104b, and 104dwithin ML processor 102. As shown in FIG. 3, the ML processor 102 may include optical coupling(s) used to make connections between nodes. For example, optical couplings may be implemented using FAUs 132a and 132b and the optical fiber 133 situated over the PIC 192 and providing optical input to grating coupler 340 in PIC 192. In another example, optical couplings may be implemented using edge coupling or any other form of coupling. The optical fiber 133 may be connected to an off-chip laser light source and/or to another processor's FAU that may provide optical input to PIC 192. In some implementations, the laser light source may be on-chip as described herein, (i.e., the laser light may not be provided through FAU 132a). Optical links, such as the waveguide 343, (and/or additional waveguides not shown), may supply the light received by grating coupler 340 to the routers 110a, 110b, and 110d situated on PIC 192.

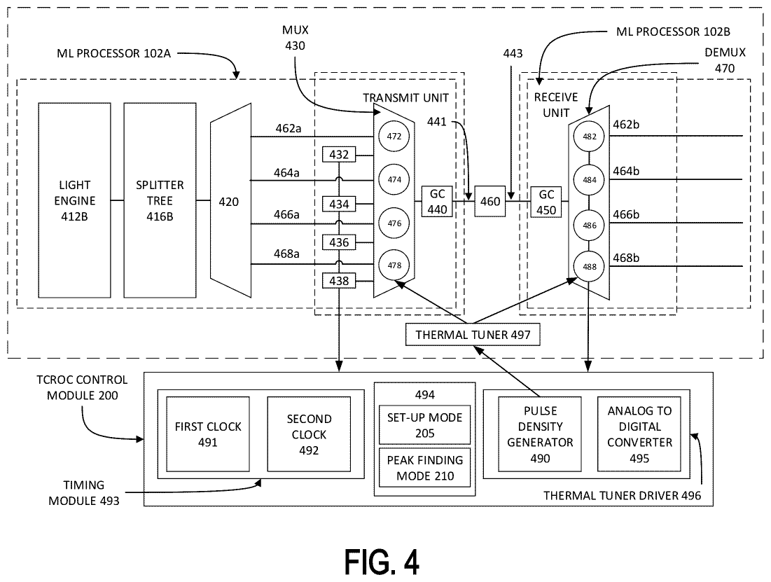

The ASIC 188 may be electrically coupled to the PIC 192. The ML processor 102 may include A TCROC control module 200 that may be communicative coupled with detectors 305. The detectors 305 may have photonic links to the TCROCs 300a and 300b, for example by an optical coupling to the waveguide 343. The detectors 305 may sense the optical energy on the waveguide 343 provided by the light engine 412B and may provide input to the TCROC control module 200. In turn, the TCROC control module 200 (for example, when using peak finding mode 210) may apply a voltage to the TCROCs 300a and/or 300b to alter their peak resonant wavelength. The TCROC control module 200 altering the peak resonant wavelength may cause the waveform of the TCROCs 300a and/or 300b to have a peak voltage that matches the wavelength of the light engine 412B. This TCROC peak wavelength shift may be proportional to the average electrical power delivered to an associated tuner (e.g., thermal tuner 497 as described herein in association with FIG. 4). The average electrical power delivered to the tuner may be determined by the duty cycle of the pulse-train for that TCROC. The average power delivered to a TCROC 300a and/or 300b may be determined by the following formula:

$${P}_{ave} = \frac{{V}^{2}}{R} \cdot \frac{t}{T} ,$$

, where
V=Height of Pulse
R=Resistance of Element of Tuner(s) That Heats Waveguide
T=Width of Pulse
t=Thermal Time Constant of Tuner(s)
   The resistance R of the tuner may be a resistance of a resistive element that heats the waveguide 343. As described herein, the height V of the pulse may be determined by and/or associated with a voltage sent to the TCROC, and the width T of the pulse may be determined and/or associated with a time over which the pulse occurs.

In some embodiments, one or more TCROCs (e.g., 300a or 300b) may be at least partially thermally insulated from one or more (e.g., surrounding) components and/or from the PIC generally. For example, the PIC may be manufactured with a thermally insulating layer, component, or feature which may reduce the thermal conductivity from the TCROC to the PIC. In some embodiments, the PIC may include a cavity or air gap such that at least a portion of the TCROC does not make physical contact with the PIC in order to reduce the flow of heat from the TCROC. As discussed herein in detail, the reduction in thermal conductivity of the TCROC may contribute to a longer thermal time constant of the TCROC, which may facilitate features and functionalities discussed herein.

As discussed herein, multiple ML processors may be connected to form a ML accelerator. In some embodiments, wavelength division multiplexing (WDM) may be implemented to for optical connections between the multiple ML processors (e.g., inter-chip or chip-to-chip optical communications) in order to reduce the number of fiber connection between the different chips. FIG. 4 illustrates an example of ML processors 102A and 102B connected in a multi-chip configuration, according to at least one embodiment of the present disclosure. FIG. 4 may include any of the features of the ML processor 102 discussed above in connection with FIGS. 2 and/or 3. FIG. 4 may show an example of WDM scheme. For example, a first chip such as the ML processor 102A may be connected to a second chip such as ML processor 102B. The chips may be connected through one or more of a grating coupler 440 in ML processor 102A, a fiber 441, a connector 460, a fiber 443, and a grating coupler 450 in ML processor 102B. A light engine 412B, which can be an on-chip or off-chip laser light source, may provide light with between 2 and 16 wavelengths to a splitter tree 416B. In some embodiments, the light engine 412B provides four wavelengths of light, λb1, λb2, λb3, and λb4 to splitter tree 416B. A demultiplexer (DEMUX) 420 may provide each wavelength λb1, λb2, λb3, and λb4 to a WDM multiplexer (MUX) 430 on optical links 462a, 464a, 466a, and 468a. A MUX 430 may comprise at least TCROCs 472, 474, 476, and 478. TCROCs 472, 474, 476, and 478 may selectively provide the modulated light with respective wavelengths λb1, λb2, λb3, and λb4 to ML Processor 102B (e.g., via the transmit unit). Modulated light with respective wavelengths λb1, λb2, λb3, and λb4 ma also be routed via optical links to monitor photodiodes (MPDs) 432, 434, 436, and 438. It should be noted that in the transmit unit, the TCROCs may have respective monitor photodiodes (MPD)s 432, 434, 436, and 438. In contrast, in the receive unit, TCROCs 482, 484, 486, and 488 may be capable of performing both the functionality of the receive photodiodes (RPDs) and also the functionality of receiving data with TCROCs 482, 484, 486, and 488, so additional circuitry may not be needed.

An output of the WDM multiplexer 430 may be provided on a single waveguide to grating coupler 440. For example, the output may contain four data streams each using a separate wavelength λb1, λb2, λb3, and λb4, and the output may be provided to fiber 441, connector 460, fiber 443, and grating coupler 450 in ML processor 102B. In some embodiments, edge coupled fibers are used in lieu of or in addition to FAUs and grating couplers. In the ML processor 102B, grating coupler 450 may receive the four data streams from a single fiber 443. The DEMUX 470 may then demultiplex the optical signal provided from a single waveguide connected to grating coupler 450 and may provide the four data streams to, respectively, TCROCs 482, 484, 486, and 488. Although the implementation discussed above is directed to a channel showing four optical links and a WDM DEMUX 470 receiving four different wavelengths, it should be understood that any number of optical links may be used, and the WDM DEMUX 470 may accordingly receive and output any number of different wavelengths.

A TCROC control module 200 may typically be included as a component in the ASIC 188. The TCROC control module 200 may include a pulse density generator 490 that may construct a pulse signal for each of the TCROCs 472, 474, 476, 478, 482, 484, 486, and 488, for example, in order to tune them back to their respective light source wavelengths λb1, λb2, λb3, and λb4. The pulse density generator 490 may be constructed in hardware and may be configured to provide the needed pulse width and height for each TCROC in the system once the optical output of the TCROC is sampled and the needed pulse signal is determined. To this end, each TCROC may be capable of sending an optical output via an electrical connection to the ASIC where the optical output may be received and converted to digital form by an analog to digital converter 495 in a thermal tuner driver 496. In some embodiments, sub-nanosecond pulse control is used by the pulse density generator 490. In some embodiments counters on two closely spaced lower frequency clocks 491 and 492 are implemented in the timing module 493. The Vernier effect may be leveraged between clocks 491 and 492 to get extremely fine resolution. For example, the output values of the two clocks 491 and 492 may be compared to pre-set thresholds, and the outputs of those two comparators may feed set and reset inputs of a flip-flop. A time resolution that may be achieved may be expressed as (1/frequency of clock 491)−(1/frequency of clock 492). For example, a frequency of the first and the second clocks 491 and 492 may be around 30 MHz with a frequency difference of 1 MHz, a time resolution of 1 nanosecond may be achieved. In some embodiments, the resolution of the wavelength control may be 0.05 nanometers in order to locate the resonance accurately. In the PDM context the minimum wavelength step may be determined by the minimum duty cycle increment that may be achieved in the system, which in turn may depend on the smallest achievable step in pulse-width (t). As described above, the incremental power delivered to the TCROC per step may be determined based on the following formula:

$${P}_{ave} = \frac{{V}^{2}}{R} \cdot \frac{t}{T}$$

Thus, for a given voltage level of each pulse signal, a value for t may be determined in order to achieve a desired wavelength resolution (e.g., such as 0.05 nm) and a corresponding resolution in tuning power.

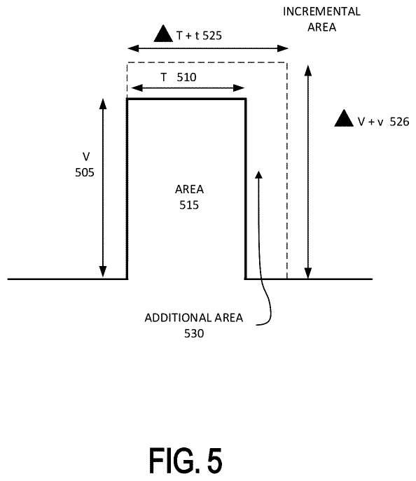

FIG. 5 illustrates an example pulse density signal generated by a pulse density generator, according to at least one embodiment of the present disclosure. A pulse signal may include both a height (V) 505 and a width (T) 510. The height 505 may represent the voltage sent to a TCROC (e.g., a larger voltage value will increase the height 505). The width 510 may be based on a time T over which the pulse signal occurs. An area 515 under the waveform may represent the amount of energy that is fed into the TCROC that the pulse density generator 490 is coupled to. The energy represented by area 515 may be the energy needed to alter the thermal characteristics of the TCROC such that the TCROC peak resonance wavelength may be tuned back to the wavelength of the laser in one or more (e.g., subsequent) time-cycles, thereby eliminating the inefficiencies previously described in FIG. 1.

In some embodiments, a variety of combinations of height (V) 505 and a width (T) 510 may generate an equivalent area 515. In some embodiments the pulse density generator is optimized for power, such as by constructing the pulse signal and/or the area 515 such that width (T) 510 is maximized and height (V) 505 is minimized. For example, as mentioned above, the height (V) may be determined by or representative of the voltage of the pulse (e.g., input voltage), and the width (T) may be based on the time (e.g., duty cycle) over which the voltage is applied. Therefore, a minimal amount of voltage may be applied to achieve a required area 515, so long as there is sufficient time to apply the pulse signal to the TCROC within the bounds of its applicable control scheme. Delta components 525 and 526 may create additional area 530 in a second waveform. This may represent a subsequent pulse signal constructed by the pulse density generator 490. For example, the height (V) and/or width (T) may be incremented, decremented, or otherwise modified (e.g., by an input voltage delta and/or duty cycle delta) in order to modify the area of a second waveform (e.g., by a modified input voltage and/or modified duty cycle) in order to provide the requisite energy delivery for tuning the TCROC(s). This may occur within a range of fractions of nanoseconds, where a signal from the pulse density generator 490 may be sent by a thermal tuner driver 496 that may individually select and control any of the TCROCs. In some embodiments, the thermal tuner driver 496 accesses the TCROCs in a 2-dimensional grid by activating a thermal tuner 497 for any given row or column of the grid, which can heat a waveguide coupled to the TCROC.

The thermal tuner driver 496 may drive the pulse density generator 490 using a controller 494. The controller may include a data structure such as a table, for example, that may pair the potential optical output of a detector with a duty signal associated with the pulse density generator 490. The controller 494 may be implemented in software and may operate on the megahertz or kilohertz range. Using this scheme, the pulse density generator 490 may have two degrees of freedom with which to alter the thermal characteristic of the TCROC. Altering the thermal characteristics within two degrees of freedom in this way may provide the advantage of visiting each TCROC less often while still achieving the required thermal alterations/tuning over time. In this manner, the timing module 492 may ensure, for example, that one pulse signal may be sent to each TCROC in a given time cycle (or multiple cycles) before cycling back and sending new pulses to the TCROC. The timing module 492 may coordinate the energy needed to send pulse density signals such that a larger pulse of heat than needed in a current cycle may be sent to a TCROC, but the signal may be sent less frequently.

As an illustrative example, a TCROC may require a certain amount of energy for a given time-cycle in order to heat the TCROC in accordance with the techniques described herein. However, in some embodiments, a pulse density signal may be designed to provide double the energy needed for the TCROC for the current time-cycle, for example, by the thermal tuner driver driving the pulse density generator 490 to construct a waveform with twice the necessary area. The timing module 493 may accordingly send a shorter burst to each TCROC that delivers twice the energy needed for the given cycle, but the signal may be sent only once every two cycles. This may be facilitated by leveraging the fact that the thermal response by the TCROC may be relatively slow and highly inertial. Thus, a given TCROC may heat at a much slower rate than the pulse density generator 490 can cycle, and the tuning bias may not need to be constantly applied. A fast train of voltage may accordingly be employed to deliver the required electrical power to the thermal tuners 497 based on an average. While this example has been described with respect to doubling the area of the pulse/energy delivered and accordingly sending the signal every two cycles, in some embodiments, other ratios may be implemented. For example, a pulse signal may be delivered of 3 times the size every 3 cycles, 4 times the size every 4 cycles and so on, consistent with that described herein.

In some embodiments, each of the TCROCS and/or thermal tuners may have an associated thermal time constant, t. The thermal time constant t may refer to how quickly the temperature of the component adjusts in response to a change in environmental conditions, change in external stimuli, etc. For example, as described herein, the thermal tuner driver 496 may deliver pulse signals to one or more TCROCs in order to adjust (e.g., raise) a temperature of the TCROC to a target temperature associated with an optimal or desirable peak resonant wavelength of the TCROC. After the pulse signal is no longer being delivered, the temperature of the TCROC may begin to fall, and accordingly the peak resonance wavelength may begin to change sub optimally, degrading performance of the TCROC. The amount of time it takes the temperature to fall to a lower, equilibrium, or threshold temperature may be defined based on the thermal time constant. In some embodiments, the thermal time constant may be the time it takes for the temperature to fall to a threshold temperature, such as an equilibrium temperature at which the TCROC may operate without being heated by the thermal tuner driver. In some embodiments, the thermal time constant may be a time it takes for the temperature to fall or change by a certain percentage from the target temperature, such the time it takes for the temperature to change 63.2% of the difference between the target temperature and the equilibrium temperature. The thermal time constant may be based on any other relevant threshold for the temperature of the TCROCs.

A variety of factors may influence the thermal time constant. For example, the thermal time constant t may be affected by the dynamics, properties, characteristics, implementations, etc., of the TCROCs and/or of the system generally. In some embodiments, the thermal time constant t is based on a thermal conductivity or resistivity of the TCROCs and/or of the system, and how heat is transferred between (e.g., from) the TCROCs to or through any surrounding components. For example, a higher thermal conductivity of the TCROCs may correspond with a shorter thermal time constant, as heat may dissipate quicker from the TCROCs to surrounding components. In a similar manner, a lower thermal conductivity of the TCROCs may correspond with a longer thermal time constant, as the TCROCs may generally hold heat for a longer period of time. In some embodiments, the TCROCs may be implemented in the PIC with a thermally insulating layer in order to reduce the thermal conductivity from the TCROCs to the PIC. For example, the PIC may include a silicon substrate, and the TCROCs may be implemented on the silicon substrate with an air pocket or gap at least partially between each TCROC and the silicon substrate to reduce heat transfer from the TCROCs to the silicon substrate. This may facilitate the implementation of the thermal tuner driver 496 and/or pulse density generator 490 with multiple TCROCs in accordance with the techniques described herein.

For example, as described herein, the TCROC control module 200 may determine and generate a pulse signal for applying to a TCROC in order to adjust the temperature and tune the peak resonance wavelength of the TCROC. The TCROC control module 200 may leverage the thermal time constant of the TCROC and may apply an electrical power to the TCROC by pulsing the TCROC (e.g., in contrast to applying a constant electrical power) in order to facilitate applying pulse signals to several TCROCs in succession.

For example, the TCROC control module 200 may apply a first pulse signal to a first TCROC to raise the TCROC to a target temperature associated with an optimal peak resonance wavelength for the first TCROC (e.g., the wavelength of a laser light source). After the first pulse signal is no longer applied, the temperature of the TCROC may begin to fall below the target temperature and accordingly the peak resonance wavelength of the first TCROC may being to change away from the optimal value. However, the temperature may fall according to the thermal time constant of the first TCROC, which may allow the TCROC control module 200 to address several additional TCROCs by applying pulse signals successively to these additional TCROCs and revisiting the first TCROC before the temperature falls below some threshold value. In this way the TCROC control module 200 may intentionally allow the temperature of each TCROC to fall to some extent below a target temperature, but may revisit each TCROC and may reapply (or apply a new/modified pulse signal) to each TCROC periodically to again bring the temperature back to the target temperature before each temperature falls below a threshold value. In this way, the TCROC control module 200 may be implemented to tune the peak resonance wavelength of a plurality of TCROCS, for example, in contrast to implementing a thermal tuner driver 496 and pulse density generator 490 for each TCROC.

In some embodiments, a minimum repetition rate per TCROC (T), or the rate or period at which the thermal tuner driver 496 and/or pulse density generator 490 revisits each TCROC, can be determined by the thermal time constant, t. In some embodiments, the minimum repetition rate T is significantly smaller than the thermal time constant t. For example, the minimum repetition rate T may be 100 times smaller (or faster) than the thermal time constant t. The minimum repetition rate T may be as little at 10 times, or as much as 1000 times faster than the thermal time constant t. For example, in some embodiments, the thermal time constant t has been experimentally found to be about 100 microseconds (μs) for the TCROCs, and the minimum repetition rate T may be 100 times smaller than the thermal time constant t, or 1 μs.

The minimum repetition rate T may be significantly smaller than the thermal time constant t in this way in order that the TCROC control module may leverage the comparatively larger thermal time constant t of the TCROCs and tune a plurality of TCROCs without allowing any TCROC to fall significantly below the target temperature. For example, by implementing a time cycle for the TCROC control module defined by the minimum repetition rate T, and pulsing each TCROC at least once during each time cycle, the TCROCs may be maintained substantially at or near the target temperature. Different minimum repetitions rates T may be implemented to achieve different purposes of the system. For example, as may be evident based on that described herein, the faster the minimum repetition rate t, the closer the TCROCs may remain to the target temperature, while slower reptations rates may permit the TCROCs to fall farther from the target temperature before being pulsed back to the target temperature. Thus, in some implementations it may be desirable to implement a shorter minimum repetition rate t, such as 1000 times faster than the thermal time constant t, in order to achieve improved performance of the TCROCs. This increase in performance may come at a cost, however, as faster operation of components may correspond with increased energy usage, increased component wear, increased operational costs, etc. In some implementations, it may be desirable to implement a longer minimum repetitions rate T, such as 10 times faster than the thermal time constant t. While such an implementation may result in reduced performance increases, the resulting energy usage, component wear, operational costs, etc., may also be reduced. These two examples may illustrate a spectrum of use-cases, and a specific implementation of the techniques described herein may apply any of a variety of minimum repetition rates T in order to achieve the goals of the specific implementation.

The TCROC control module 200 may operate in accordance with the minimum repetition rate T in this way in order to facilitate pulsing a plurality of TCROCs. For example, the minimum repetition rate T may define a time cycle for operation of the TCROC control module 200. Each time cycle, the TCROC control module 200 may pulse each TCROC which it controls/with which it is associated. The time cycle may be segmented into non-overlapping portions or segments such that each TCROC is associated with a distinct segment of the time cycle, and the TCROC control module 200 may visit or address each TCROC during its associated segment. In some embodiments, the time cycle is divided into equal segments such that each TCROC is associated with a segment of equal duration. In some embodiments, one or more of the segments may be longer or shorter than another segment. The TCROC control module may pulse and/or control any number of TCROCs and may accordingly segment the time cycle into any number of segments in order to pulse each TCROC at a distinct and non-overlapping segment of the time cycle. For example, the TCROC control module 200 may be associated with n TCROCs, and may accordingly address and/or pulse each TCROC at segments of T/n in length.

As mentioned above, the thermal tuner driver 496 and/or the pulse density generator 490 may apply a pulse signal to each TCROC in order to raise the temperature of the TCROC to a target temperature associated with an optical peak resonance wavelength for the TCROC. Techniques for determining the pulse signal (e.g., voltage and/or duration of the pulse signal) to apply to a given TCROC are described herein. In some embodiments, the TCROC control module 200 modifies or updates the pulse signal to apply to a given (or each) TCROC one or more times. For example, the TCROC control module 200 may update the pulse signal each time cycle in order to fine tune the peak resonance wavelength shift. In another example, the TCROC control module 200 may update the pulse signal at some other interval of time cycles.

Referring back to FIG. 4, the controller 494 may be a software module that may control the thermal tuner driver 496 and/or the pulse density generator 490 to supply the thermal tuner 497 with the appropriate voltage for the current thermal condition of the TCROC. The controller 494 may be communicatively coupled to one or more of the MPDs 432, 434, 436, 438 and the TCROCs 482, 484, 486, and 488. The DEMUX 470 has been shown and described with the functionality of a receive unit, and the TCROCs 482, 484, 486, and 488 may accordingly be photodiodes implemented in the PIC to receive an optical signal and provide it to the ASIC in electrical form. It should be understood, however, that in some embodiments the DEMUX 470, and/or the TCROCs 482, 484, 486, and 488 may also be implemented as input(s) to the TCROC control module 200. Unlike the receive unit in such an embodiment, the transmit unit including the MUX 430 may not have photodiodes, and MPDs 432, 434, 436, 438 may be coupled to the MUX 430 to serve the purpose of providing input to the TCROC control module 200.

The output of the MPDs 432, 434, 436, 438 and TCROCs 482, 484, 486, and 488 may comprise the light sampled along the waveguide in the PIC 192 that is on the same fiber as the TCROC. The detected light by the MPDs 432, 434, 436, 438 and TCROCs 482, 484, 486, and 488 may be input to the controller 494 using an electrical coupling between the ASIC and the PIC. For example, the electrical coupling may be a through-substrate-via such as a copper pillar structure, bump attachment unit, or any connection capable of being made between a PIC 192 and an ASIC 188. In some embodiments, such as where less frequent but larger bursts of energy are used, the controller 494 may sample the MPDs 432, 434, 436, 438 and TCROCs 482, 484, 486, and 488 in a megahertz or a kilohertz range using timing module 493. The controller 494 may cause the thermal tuner driver 496 to drive the TCROCs using the pulse density generator 490, whereby the pulse density generator 490 may be instructed to generate pulse signals with waveforms characterized by multiples of the heat needed for any TCROC in a given time-cycle. In some embodiments, slow and fast clock signals are obtained by utilizing the Vernier effect from leveraging the first clock signal 491 and the second clock signal 492. Typically, a fast signal may be at least an order of magnitude faster than the first and second clocks 491 and 492. However, at a minimum the leveraged fast clock signal may have twice the frequency of the first and second clock signals 491 and 492. In some embodiments, the higher-speed signal may be used to drive two or more TCROCs each time a time-cycle repeats in the timing module 493. In some embodiments, hundreds or thousands of TCROCs are controlled where the higher-speed signal is a much smaller fraction of the duration of a clock-cycle from the timing module 493.

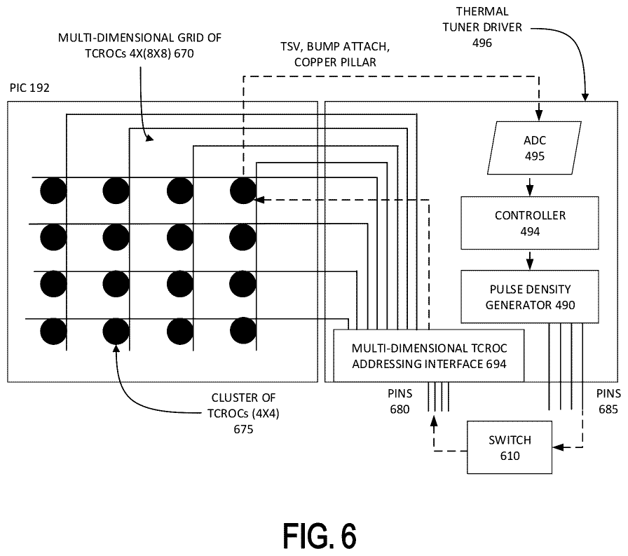

FIG. 6 shows an example thermal tuner driver 496, according to at least one embodiment of the present disclosure. As described herein, the thermal tuner driver 496 may be used for tuning TCROCs in an ML accelerator. The thermal tuner driver 496 may be coupled to a multi-dimensional grid of TCROCs 670. The grid may include four (8×8) clusters of TCROCs 675, (256 total TCROCs), which may be addressed individually using a multi-dimensional addressing interface 694. As shown in FIG. 6, 64 pins 680 may provide input to the multi-dimensional addressing interface 694 which may enable 64 clusters of four TCROCs to be addressed using row and column format, for example. The size, arrangement, and dimensionality of the TCROC grid may vary in different embodiments. An analog-to-digital converter 495 may receive the optical output from detectors associated with the TCROC clusters 675 (in the case of a transmit unit) or the optical output of the TCROC itself in the case of a receive unit. This may include, for example, a direct coupling and/or a chip-to-chip connection (not shown) between the PIC 192 and the thermal tuner driver 496. For instance, the thermal tuner driver 496 may be stacked on top of the PIC 192 such that electrical communication is enabled between the RPDs and/or MPDs and the ADC 495. In some embodiments, the optical output of the detectors may be transmitted via an electrical connection, such as a through-silicon-via, a copper pillar, a bump attachment unit, or any suitable electrical connection.

The photo-current readback from the detectors may be implemented using the ADC 495 and a current comparator. The comparator may give rail-to-rail swing based on the polarity of the input current, which in turn may be the difference between the photo-current and the output of the ADC 495. To make a current measurement, the ADC 495 may be swept monotonically or may implement a binary search. The controller 494 may use the digital output of the ADC 495 to enable the pulse density generator 490 to construct the appropriate signal for any given TCROC. The signal may be transmitted via pins 685 and may become input on pins 680 after being sent via a switch 610, which may include FETs, for example, between the output pins 685 and the input pins 680.

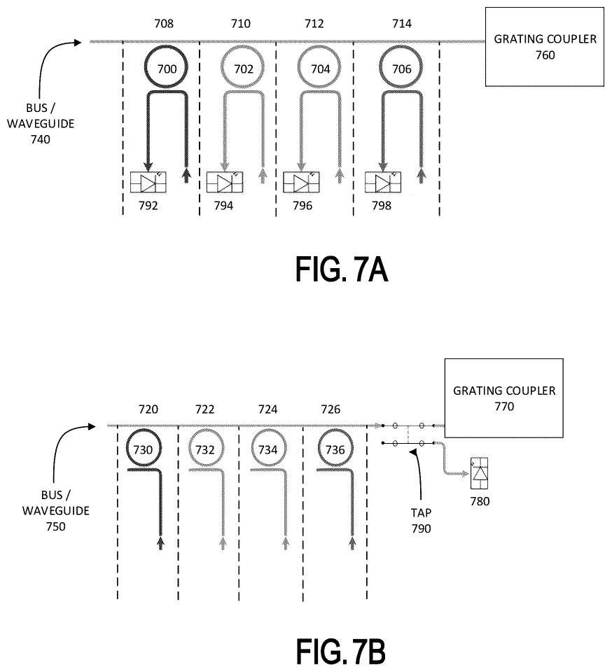

FIGS. 7A and 7B illustrate various architectures by which the MPDs may sample light in the waveguides of a PIC 192 and provide the sampled light to closed-loop control circuit(s) implemented by the TCROC control module 200, according to at least one embodiment of the present disclosure. In FIG. 7A, an architecture is shown which may include one MPD 792, 794, 796, and 798 in each through-port of each channel 708, 710, 712, and 714. In some embodiments, TCROCs 700, 702, 704, and 706 are placed in channels 708 through 714. MPDs 792 through 798 may each be placed at a through-port associated with the TCROC with which it is paired. The MPDs 792, 794, 796, and 798 may receive optical power from one of the TCROCs 700, 702, 704, and 706 on a bus/waveguide 740 as the optical signal travels to a grating coupler 760. The MPDs 792 through 798 may reside in the PIC 192 and may be positioned below and/or adjacent to associated control circuitry in the ASIC 188 associated with the TCROC control module 200. This may enable maximum fidelity in the electrical connections between the output of the MPDs 792 through 798 and the input to the TCROC control module 200 as signals are routed out of the PIC 192.

In FIG. 7B, an architecture is shown which may include a single MPD 780 tapped off a bus/waveguide 750 for each group of 4 channels. In the current example, TCROCs 730, 732, 734, and 736 reside in channels 720, 722, 724, and 726. In some embodiments, a tap 790 connects the bus/waveguide 750 with an MPD 780 while the remainder of the light travels from the bus/waveguide 750 to a grating coupler 770. The tap may utilize 5% of the optical signal on the bus/waveguide 750, or another suitable amount. As with the scheme of FIG. 7A, the MPD 780 may be positioned below and/or adjacent to associated control circuitry in the ASIC 188 associated with the TCROC control module 200 to reduce latency.

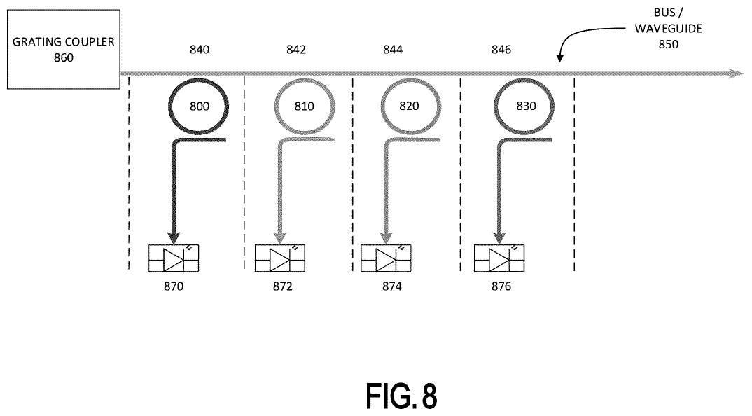

FIG. 8 illustrates an architecture by which RPDs sample light in the waveguides of the PIC 192 and provide the sample light to closed-loop control circuit implemented by the TCROC control module 200, according to at least one embodiment of the present disclosure. The architecture may include one RPD 870, 872, 874, and 876 in each through-port of each channel 840, 842, 844, and 846. In some embodiments, TCROCs 800, 810, 820, and 830 are placed in channels 840 through 846. RPDs 870 through 876 may each be placed at a through-port associated with the TCROC it is paired with. The RPDs 870, 872, 874, and 876 may receive optical power from one of the TCROCs 800, 810, 820, and 830 on a bus/waveguide 850 as the light travels from a grating coupler 860. In some embodiments, the RPDs 870 through 876 use a DC component of the optical signal incident on receiver photodetectors (e.g., already present in the portion of the receive units that reside in the PIC 192). The presence of DC offset compensation at the input of a TIA (e.g., the portion of the receive unit that resides in the ASIC 188) may give a readily usable current mirror to measure the DC photocurrent. The RPDs 870 through 876 may reside in the PIC 192 and may be positioned below and/or adjacent to associated control circuitry in the ASIC 188 associated with the TCROC control module 200. This may enable maximum fidelity in the electrical connections between the output of the RPDs 870 through 876 and the input to the TCROC control module 200 as signals are routed out of the PIC 192.

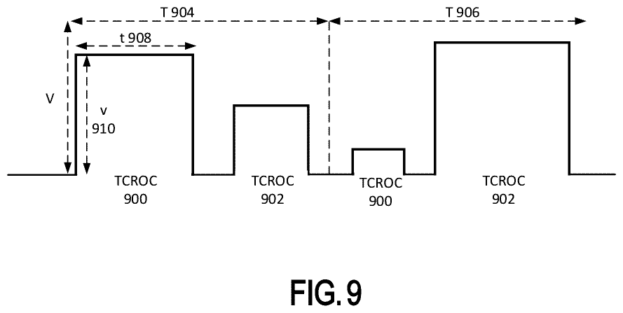

FIG. 9 illustrates an operation of a TCROC control module 200 controlling a system having two TCROCs, according to at least one embodiment of the present disclosure. The PDM scheme for TCROC control of FIG. 9 may involve sending voltage pulses to each TCROC 900 and 902 in order to tune the resonance(s) to a laser wavelength in that band. As mentioned earlier, the TCROC peak wavelength shift may be proportional to the average electrical power delivered to its tuner, which in turn may be determined by the duty cycle of the pulse-train for that ring. TCROC 900 in time-cycle T (904) may have a duty cycle with a width of t (908) and a voltage v (910) during the time slice or duration represented by t (908). The remaining time slice in the time cycle T (904) may have a pulse train applied to TCROC 902 in an analogous manner. Thereafter, the process may repeat at time-cycle T (906) which may also include time slices for TCROCs 900 and 902. It should be noted that in a two TCROC configuration the time slices may be less than or equal to half the frequency of the first time-cycle. In implementations with more than two TCROCs, the frequency of the time slices in each time-cycle may be smaller in duration. It should also be noted that in systems that optimize for power, the pulse train for each TCROC 900 and 902 may be configured to minimize the magnitude of voltage v (910) and maximize the duration of width t (908), so long as there is sufficient time to deliver all of the needed pulses in any given time-cycle, as described herein. This may allow the system to use the least amount of power possible, while obtaining the correct signals needed by the TCROCs to operate at the desired peak resonance wavelengths.

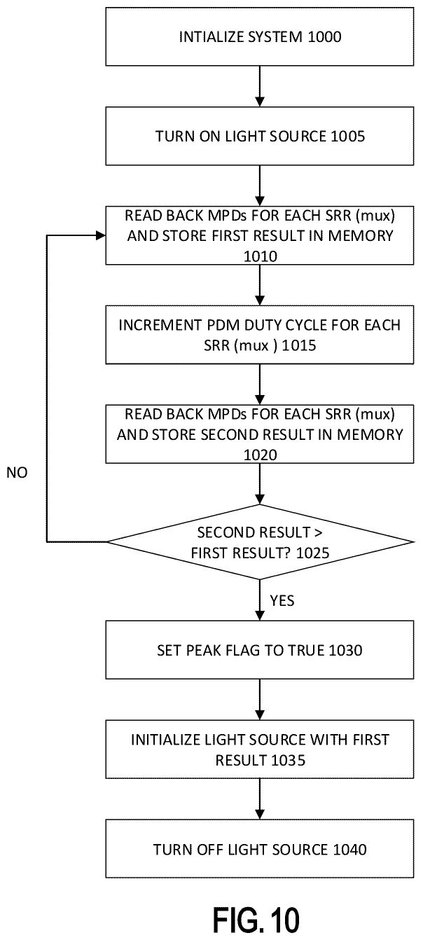

FIG. 10 is a flowchart showing the operation of a startup procedure for an embodiment of a system that uses MUXes in a PIC and/or for a transmit unit that uses TCROCs in a photonic portion, according to at least one embodiment of the present disclosure. At operation 1000, the system may be initialized. This may include, for example, ensuring that the thermal tuning power supplied to each TCROC is greater than a minimum value, for example, to ensure that any subsequent increases in PIC temperature can be handled by reducing the tuning power. For instance, to provide a margin that is 35° C. above startup temperature, an accommodation may be made to blue-shift the peak wavelengths by up to 2.5 nanometers at operation 1000. At operation 1005, the light source may be turned on. At operation 1010, the MPDs for each TCROC (MUX) may be read back and a first result stored in memory. At operation 1015, the PDM duty cycle may be incremented for each TCROC (MUX). Thereafter, at operation 1020, the MUX TCROCs may be read back again and a second result stored in memory. At operation 1025, the first and the second results may be compared. When the second result is larger than the first result, the process may repeat at operation 1010. The process may continue until the second result no longer exceeds the first result at operation 1025. This may occur for example, when the PDM duty cycle increases causing the peak resonance of the TCROC to move past the peak wavelength. When this occurs, the system may use the first result as the peak. To that end, a peak flag may be set to true at operation 1030. The light source may be initialized with the first result at operation 1035 and the light source may be turned off at operation 1040.

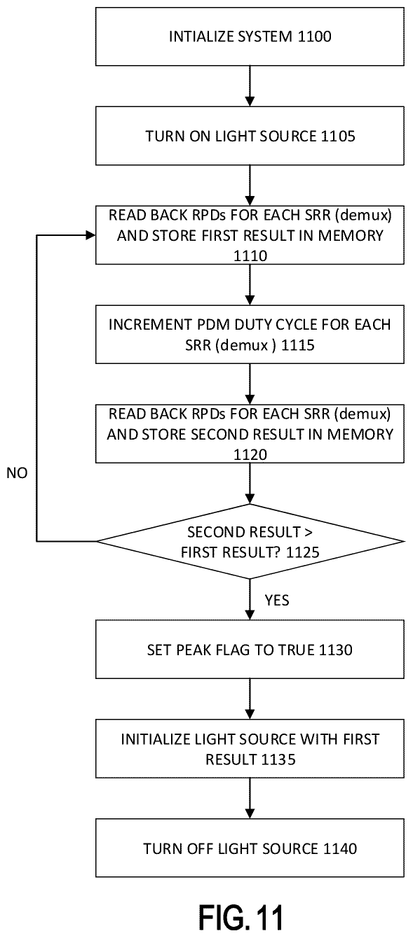

FIG. 11 is a flowchart showing the operation of a startup procedure for an embodiment of a system that uses DEMUXes in a PIC and/or for a receive unit that has photodetectors in a photonic portion of its message router, according to at least one embodiment of the present disclosure. At operation 1100, the system may be initialized, for example, by ensuring that the thermal tuning power supplied to each TCROC is greater than a minimum value to ensure that any subsequent increases in PIC temperature can be handled by reducing the tuning power. At operation 1105, the light source may be turned on. At operation 1110, the RPDs for each TCROC (DEMUX) may be read back and a first result stored in memory. At operation 1115, the PDM duty cycle may be incremented for each TCROC (DEMUX). Thereafter, at operation 1120, the DEMUX TCROCs may be read back again and a second result stored in memory. At operation 1125, the first and the second results may be compared. When the second result is larger than the first result, the process may repeat at operation 1110. The process may continue until the second result no longer exceeds the first result at operation 1125. Thereafter, a peak flag may be set to true at operation 1130, the light source may be initialized with the first result at operation 1135, and the light source may be turned off at operation 1140.

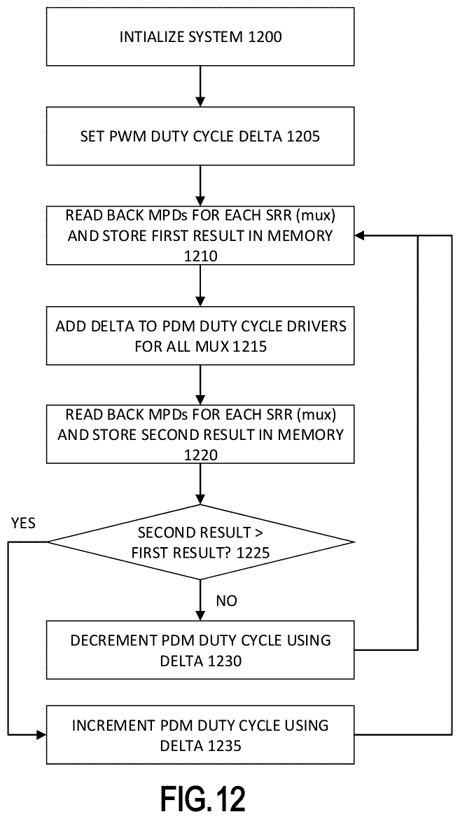

FIG. 12 is a flowchart showing the operation of a peak-tracking procedure for an embodiment of a system that uses MUXes in the PIC and/or for a transmit unit that uses TCROCs in a photonic portion, according to at least one embodiment of the present disclosure. At operation 1200, the system may be initialized. This may include, for example, setting the timing wherein a refresh rate for first and second clock systems is set to tracking. This may enable various embodiments to create and send pulses to the TCROCs at high speeds, while implementing a software control circuit at a much lower speed. This may also include setting a DC minimum voltage that may be provided to a control module and/or driver that may create and send pulse-density signals to TCROCs. At operation, 1205 a pulse-density modulation duty cycle delta may be set. This may be used to represent the minimum step that the PDM duty cycle may be modulated whenever the duty cycle is altered.

At operation 1210, the MPD's for each TCROC (MUX) may be read back and a first result stored in memory. At operation 1215, the delta may be added to the PDM duty cycle drivers for each MUX. Thereafter, at operation 1220, the MUX TCROCs may be read back again and a second result stored in memory. At operation 1225, the first and the second results may be compared. When the second result is larger than the first result, the PDM duty cycle may be incremented using the delta at operation 1235 and the process may repeat at operation 1210. Otherwise, the PDM duty cycle may be decremented using the delta at operation 1230 and the process may repeat at operation 1210. The process may repeat in a closed-loop whenever peak tracking mode is enabled in the controller and/or the system is operating.

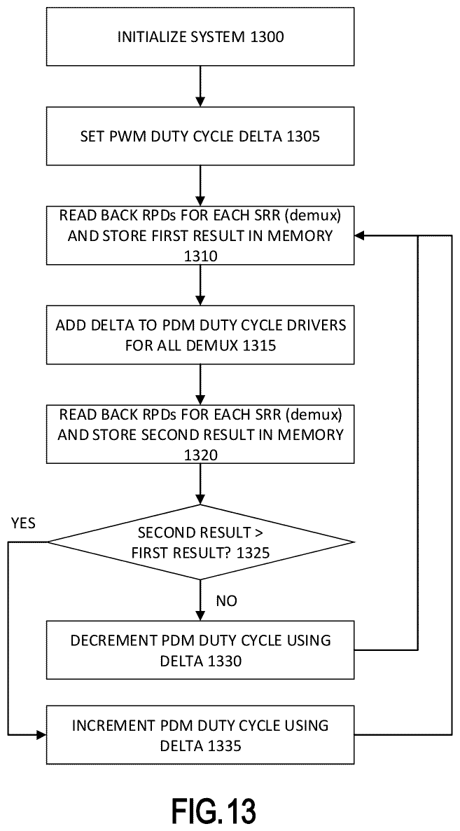

FIG. 13 is a flowchart showing the operation of a peak-tracking procedure for an embodiment of a system that uses DEMUXes in the PIC and/or for a receive unit that has photodetectors in a photonic portion of its message router, according to at least one embodiment of the present disclosure. At operation 1300, the system may be initialized. At operation, 1305 a pulse-density modulation duty cycle delta may be set. This may be used to represent the minimum step that the PDM duty cycle may be modulated whenever the duty cycle is altered. At operation 1310, the RPDs for each TCROC (DEMUX) may be read back and a first result stored in memory. At operation 1315, the delta may be added to the PDM duty cycle drivers for each DEMUX. Thereafter, at operation 1320, the DEMUX TCROCs may be read back again and a second result stored in memory. At operation 1325, the first and the second results may be compared. When the second result is larger than the first result, the PDM duty cycle may be incremented using the delta at operation 1335 and the process may repeat at operation 1310. Otherwise, the PDM duty cycle may be decremented using the delta at operation 1330 and the process may repeat at operation 1310. The process may repeat in a closed-loop whenever peak tracking mode is enabled in the controller and/or the system is operating.

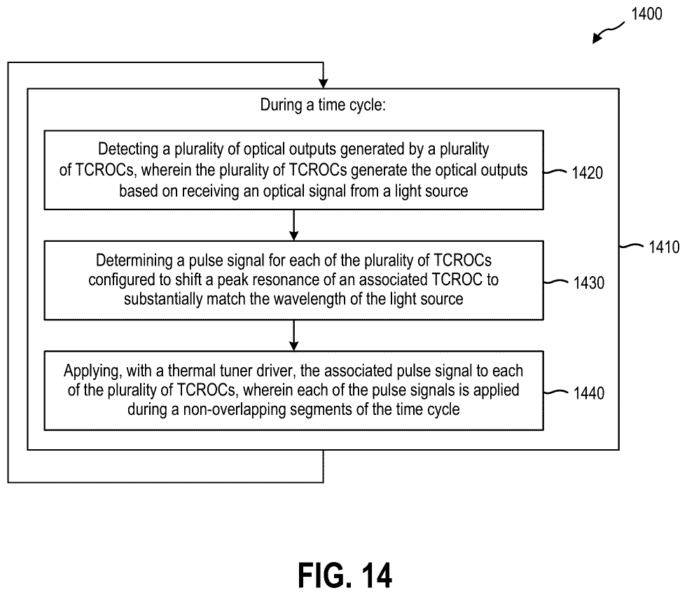

FIG. 14 is a flow diagram for a method 1400 or a series of acts for tuning TCROCs of a PIC as described herein, according to at least one embodiment of the present disclosure. While FIG. 14 illustrates acts according to one embodiment, alternative embodiments may add to, omit, reorder, and/or modify any of the acts of FIG. 14.

In some embodiments, the method 1400 includes an act 1410 of performing one or more sub acts during a time cycle. For example, the time cycle may be recurring, and the sub acts may be performed during each time cycle for several consecutive iterations of the time cycle. As shown, the act 1410 and the included sub acts may be performed or looped two or more times. In some embodiments, the time cycle is determined based on a thermal time constant of the plurality of TCROCS.

In some embodiments, the method includes an act 1420 (e.g., a sub act) of detecting a plurality of optical outputs generated by the plurality of TCROCs. The plurality of TCROCs may generate the plurality of optical outputs based on receiving an optical signal from a light source. The plurality of TCROCs may include one or more of a multiplexer and a demultiplexer.

In some embodiments, the method includes an act 1430 (e.g., a sub act) of determining a pulse signal for each of the plurality of TCROCs configured to shift a peak resonance wavelength of an associated TCROC to substantially match the wavelength of the light source. The pulse signals may each be determined based on an electrical power to apply to each TCROC, wherein the electrical power is determined based on a voltage and a duration of the pulse signal. The pulse signals may each be configured to change a temperature associated with a corresponding TCROC, and the shift in the peak resonance of the TCROC may be based on the associated change in temperature.

In some embodiments, the method includes an act 1440 (e.g., a sub act) of applying, with a thermal tuner driver, the associated pulse signal to each of the plurality of TCROCs, wherein each of the pulse signals is applied during a non-overlapping segment of the time cycle. The thermal tuner driver may be connected to each of the TCROCs via a switchable circuit such that each TCROC is selectively connectable to the thermal tuner driver. For example, the plurality of TCROCs may include “n” TCROCs and the time cycle may be divided into n segments that each have a maximum duration of:

Time Cycle/n

In some embodiments, the consecutive iterations of the time cycle include a first time cycle and a second time cycle of equal length. During the first time cycle, a first plurality of pulse signals may be determined and applied to the plurality of TCROCs, and during a second time cycle, a second plurality of pulse signals may be determined and applied to the plurality of TCROCs. At least one TCROC may have a pulse signal that is different for the first time cycle and the second time cycle.

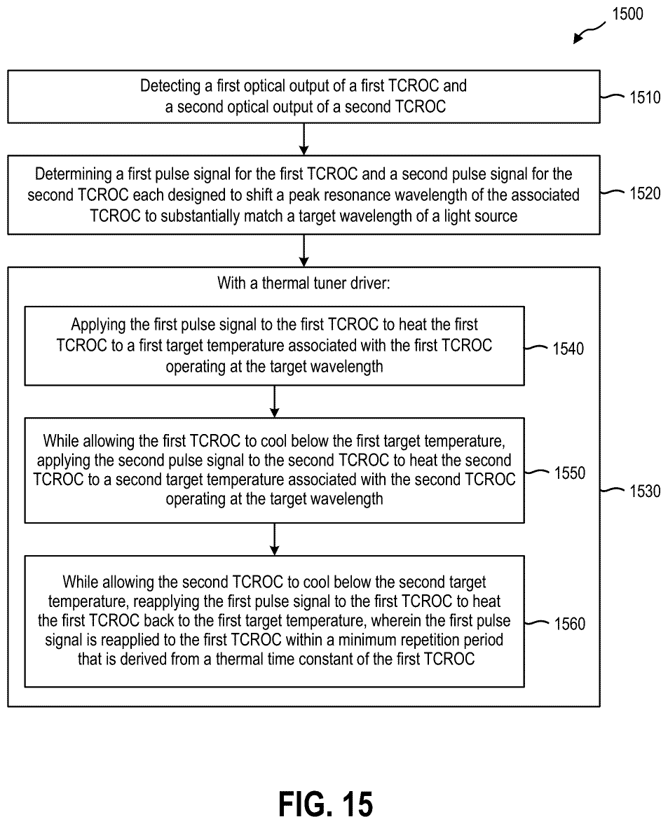

FIG. 15 is a flow diagram for a method 1500 or a series of acts for tuning TCROCs of a PIC as described herein, according to at least one embodiment of the present disclosure. While FIG. 15 illustrates acts according to one embodiment, alternative embodiments may add to, omit, reorder, or modify any of the acts of FIG. 15.

In some embodiments, the method 1500 includes and act 1510 of detecting a first optical output of a first TCROC and a second optical output of a second TCROC.

In some embodiments, the method 1500 includes an act of 1520 of determining a first pulse signal for the first TCROC and a second pulse signal for the second TCROC each designed to shift a peak resonance wavelength of the associated TCROC to substantially match a target wavelength of a light source.

In some embodiments, the method 1500 includes an act 1530 of performing one or more sub acts with a thermal tuner driver. For example, the thermal tuner driver may perform any of the acts 1540, 1550, or 1560 described below.

In some embodiments, the method 1500 includes an act 1540 (e.g., a sub act) of applying the first pulse signal to the first TCROC to heat the first TCROC to a first target temperature associated with the first TCROC operating at the target wavelength.

In some embodiments, the method 1500 includes an act 1550 (e.g., a sub act) of, while allowing the first TCROC to cool below the first target temperature, applying the second pulse signal to the second TCROC to heat the second TCROC to a second target temperature associated with the second TCROC operating at the target wavelength.

In some embodiments, the method 1500 includes an act 1560 (e.g., a sub act) of, while allowing the second TCROC to cool below the second target temperature, reapplying the first pulse signal to the first TCROC to heat the first TCROC back to the first target temperature, wherein the first pulse signal is reapplied to the first TCROC within a minimum repetition period that is derived from a thermal time constant of the first TCROC. The thermal time constant may be based on a thermal conductivity of the first TCROC. For example, the thermal time constant may be a time period that the TCROC takes to fall from the first target temperature to an equilibrium temperature after the first pulse signal is not applied. In some embodiments, the minimum repetition period is at least ten times shorter than the thermal time constant. The minimum repetition period may be a recurring time cycle, and the first and second pulse signals may be alternatingly applied to the first and second TCROCs each time cycle. In some embodiments, the first pulse signal may be modified and reapplied to the first TCROC as a modified first pulse signal. For example, the first pulse signal may be modified to tune the first TCROC based on a response of the first TCROC from the first signal being applied.

In summary, according to various implementations of the present inventive concepts, the present EP-NoC includes a novel scheme for tuning optical components in the EP-NoC. The presently disclosed EP-NoC may result in a significant improvement in the performance of TCROCs. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A method of tuning temperature controlled resonant optical components (TCROCs) of a photonic integrated circuit (PIC), comprising:
at several consecutive iterations of a time cycle:
detecting a plurality of optical outputs generated by the plurality of TCROCS, wherein the plurality of TRCOCs generate the plurality of optical outputs based on receiving an optical signal from a light source;
determining a pulse signal for each of the plurality of TCROCs configured to shift a peak resonance wavelength of an associated TCROC to substantially match the wavelength of the light source;
applying, with a thermal tuner driver, the associated pulse signal to each of the plurality of TCROCs, wherein each of the pulse signals is applied during a non-overlapping segment of the time cycle.

2. The method of claim 1, wherein the time cycle is determined based on a thermal time constant of the plurality of TCROCs.

3. The method of claim 1, wherein the thermal tuner driver is connected to each of the TCROCs via a switchable circuit such that each TCROC is selectively connectable the thermal tuner driver.

4. The method of claim 1, wherein the plurality of TCROCs includes “n” TCROCs, and wherein the time cycle is divided into n segments that each have a maximum duration of:
Time Cycle/n

5. The method of claim 1, wherein the consecutive iterations of the time cycle include a first time cycle and a second time cycle of equal length, and wherein during the first time cycle, a first plurality of pulse signals are determined and applied to the plurality of TCROCs, and wherein during the second time cycle, a second plurality of pulse signals are determined and applied to the plurality of TCROCs, at least one TCROC having a pulse signal that is different for the first time cycle and the second time cycle.

6. The method of claim 1, wherein determining the pulse signal for each of the TCROCs includes determining an electrical power to apply to the TCROC, wherein the electrical power is determined based on a voltage and a duration of the pulse signal.

7. The method of claim 1, wherein each pulse signal is configured to change a temperature associated with a corresponding TCROC, and wherein the shift in the peak resonance of the TCROC is based on the associated change in the temperature.

8. The method of claim 1, wherein the plurality of TCROCs includes one or more of a multiplexer and a demultiplexer.

9. A method of tuning temperature controlled resonant optical components (TCROCs) of a photonic integrated circuit (PIC), comprising:
detecting a first optical output of a first TCROC and a second optical output of a second TCROC;
determining a first pulse signal for the first TCROC and a second pulse signal for the second TCROC each designed to shift a peak resonance wavelength of the associated TCROC to substantially match a target wavelength of a light source; and
with a thermal tuner driver:
applying the first pulse signal to the first TCROC to heat the first TCROC to a first target temperature associated with the first TCROC operating at the target wavelength;
while allowing the first TCROC to cool below the first target temperature, applying the second pulse signal to the second TCROC to heat the second TCROC to a second target temperature associated with the second TCROC operating at the target wavelength; and
while allowing the second TCROC to cool below the second target temperature, reapplying the first pulse signal to the first TCROC to heat the first TCROC back to the first target temperature, wherein the first pulse signal is reapplied to the first TCROC within a minimum repetition period that is derived from a thermal time constant of the first TCROC.

10. The method of claim 9, wherein the thermal time constant is based on a thermal conductivity of the first TCROC.

11. The method of claim 9, wherein the thermal time constant is a time period that the TCROC takes to fall from the first target temperature to an equilibrium temperature after the first pulse signal is not applied.

12. The method of claim 9, wherein the minimum repetition period is at least ten times shorter than the thermal time constant.

13. The method of claim 9, wherein the minimum repetition period is a reoccurring time cycle, and wherein the first and second pulse signals are alternatingly applied to the first and second TCROCs each time cycle.

14. The method of claim 9, wherein reapplying the first pulse signal includes modifying the first pulse signal to tune the first TCROC based on a response of the first TCROC from the first signal being applied.

15. A device for tuning optical components of a photonic integrated circuit (PIC), comprising:
a first thermally controlled resonant optical component (TCROC) configured to receive light from a light source and generate a first optical output, the first TCROC having a first peak resonance wavelength that varies with a first temperature of the first TCROC;
a second TCROC configured to receive light from the light source and generate a second optical output, the second TCROC having a second peak resonance wavelength that varies with a second temperature of the second TCROC;
at least one detector operatively coupled to the first and second TCROCs for detecting the first and second optical outputs;
a control module configured to determine, based on the first and second optical outputs detected by the at least one detector:
a first pulse signal designed to change the first temperature and cause the first peak resonance wavelength to substantially match a wavelength of the light source; and
a second pulse signal designed to change the second temperature and cause the second peak resonance wavelength to substantially match the wavelength of the light source; and
a thermal tuner driver configured to apply the first pulse signal to the first TCROC and apply the second pulse signal to the second TCROC.

16. The device of claim 15, wherein the thermal tuner driver is configured to apply the first pulse signal and the second pulse signal during each of a recurring time cycle.

17. The device of claim 16, wherein the control module is configured to determine updated first and second pulse signals for each time cycle.

18. The device of claim 15, wherein the first and second TCROCs are included in the PIC and are each thermally insulated from a silicon substrate of the PIC by an air pocket between the first and second TCROCs and the silicon substrate.

19. The device of claim 15, wherein the control module and the thermal tuner driver are included in an electronic integrated circuit separate from the PIC.

20. The device of claim 15, wherein the first and second TCROCs include one or more of a multiplexer, a demultiplexer, a ring switch, and a Mach-Zehnder interferometer-based switch.
